(19) United States
(12) Patent Application Publication
(10) Pub. No.: US 2024/0385117 A1
(43) Pub. Date: Nov. 21, 2024

(54) INDICATOR FOR MEASURING PERCARBOXYLIC ACID CONCENTRATION AND METHOD FOR MEASURING PERCARBOXYLIC ACID CONCENTRATION USING SAME

(71) Applicant: SARAYA CO., LTD., Osaka (JP)

(72) Inventors: Satomi SAKAI, Kashiwara (JP); Tadashi MATSUMOTO, Osaka (JP); Emiko KAWAMUKAI, Kashiwara (JP); Toru YASUHARA, Osaka (JP)

(73) Assignee: SARAYA CO., LTD., Osaka (JP)

(21) Appl. No.: 18/689,702

(22) PCT Filed: Nov. 30, 2021
(86) PCT No.: PCT/JP2021/043862

§ 371 Date: Mar. 6, 2024

(30) Foreign Application Priority Data
Sep. 6, 2021 (JP) 2021-145061

(51) Int. Cl. G01N 21/78; G01N 31/22

(52) U.S. Cl. CPC G01N 21/78; G01N 31/22

(57) ABSTRACT

The present invention relates to a reagent for measurement of a percarboxylic acid concentration of a percarboxylic acid-containing aqueous solution with high accuracy using an optical method, and a method for measuring and a device capable of measuring using the reagent. As an indicator solution to be used for measuring a percarboxylic acid concentration in a percarboxylic acid-containing aqueous solution (test sample), the indicator solution is used that contains Brilliant Blue FCF as an internal standard substance and an iodide salt as a coloring substance.

### TECHNICAL FIELD

The present invention relates to a method for measuring a percarboxylic acid concentration of a percarboxylic acid-containing aqueous solution with high accuracy using an optical method. The present invention also relates to a reagent and a device used in the method.

### BACKGROUND ART

The effectiveness of a bactericide depends on the working concentration, the working temperature, and the working time. Some bactericides are an equilibrium mixture having an unstable concentration, and some are unstable due to, for example, decomposition by an organic substance. For example, percarboxylic acids such as peracetic acid are used in the food hygiene field and the medical field, and are strongly required to be subjected to concentration control as well as history control. However, influence of the temperature or ultraviolet rays, and mixing of water or an organic substance may promote decomposition of percarboxylic acids. Therefore, in order to ensure the target sterilization ability, the concentration is to be precisely measured.

In view of the above problem, a titration device is provided for precisely measuring a concentration of a percarboxylic acid, particularly a peracetic acid. However, the titration device is expensive and requires an experimental reagent, and an operator of the device needs to have analysis knowledge and skilled analysis work ability. Another in-line concentration meter is provided that measures a peracetic acid concentration electrochemically, but this meter is also expensive, and has a problem that only a predetermined peracetic acid solution can be measured. In addition, there is also a problem that the meter cannot be easily carried.

Meanwhile, many users involved in concentration control in the food hygiene field and the medical field have never been involved in precise analysis work. The users need to perform periodical confirmation of the effectiveness of the bactericide concentration in addition to the usual work, and therefore it is desirable that the work of confirming the percarboxylic acid concentration can be easily performed.

Conventionally known methods of measuring a concentration of a percarboxylic acid, particularly peracetic acid, include a direct measuring method and indirect measurement. For example, PTL 1 (Japanese Patent No. 4722513) proposes, as a direct measuring method, a method of calculating a peracetic acid concentration in an aqueous solution containing peracetic acid from a calibration curve using absorbance (an intensity value of transmitted light) in an ultraviolet wavelength range (wavelength 180-210 nm) including a wavelength of 190 nm or less. However, this method requires a special and expensive light source and a precise detector, and cannot be conveniently used by a general user such as a medical worker. Furthermore, there is a problem that the peracetic acid concentration can be measured only in an aqueous solution containing only peracetic acid, hydrogen peroxide, and acetic acid, that is, if an organic substance or the like is mixed in the aqueous solution, the peracetic acid concentration cannot be measured. Examples of the indirect measurement method include, first, a method of evaluation by color of a test paper, but there are problems that the method is semi-quantitative, affected by subjectivity of a worker, and poor in objectivity and accuracy, and that digital record cannot be left in the method. Second, there is a method of measurement by analyzing an absorption change due to iodide ion generation in a reaction kinetic manner (PTL 2 (Japanese Patent No. 5491389)), but as in PTL 1, there are problems that an expensive light source is required because ultraviolet absorption is used, that the reaction rate is susceptible to temperature, that complicated calculation is required, and that target accuracy cannot be obtained. Third, there is a method of measuring a peracetic acid concentration from an absorbance change after adding a bactericide to be measured to an indicator solution (PTL 3 (Japanese Patent No. 4359336)). However, this method requires precise quantitating in which a user accurately measures the solution with a safety pipettor at the time of measurement, and particularly in the operation of the pipettor, an unskilled user may cause an operation error, and thus there is a possibility that an accurate concentration cannot be measured.

### CITATION LIST

### Patent Literature

PTL 1: JP2006-258491A
PTL 2: WO2008/149247A
PTL 3: WO2008/133321A

### SUMMARY OF INVENTION

### Technical Problem

An object of the present invention is to provide a method that enables anyone to measure the percarboxylic acid concentration of a percarboxylic acid-containing aqueous solution easily and accurately (method for quantifying a percarboxylic acid highly accurately).

The method of measuring a percarboxylic acid concentration described in PTL 3 is a method developed by the applicant. In the method, potassium iodide is added to an aqueous solution containing a percarboxylic acid such as peracetic acid to generate iodine, the amount of the generated iodine is determined by measuring the absorbance at a wavelength of 440 to 600 nm, preferably 470 nm to measure the concentration of the percarboxylic acid in the aqueous solution indirectly. However, the measurement accuracy depends on the amount (concentration in the reaction liquid) of the potassium iodide added, and therefore, as described above, the operation of adding with a safety pipettor requires precision, and thus this method is not a method that can be always performed by anyone easily. An object of the present invention is to provide a method that enables anyone to measure a percarboxylic acid concentration easily and accurately by eliminating a possible error depending on operation, such as an operation error, while the method of measuring a percarboxylic acid concentration described in PTL 3 (hereinafter, also referred to as “KI method”) is used, and to further provide a method that enables accurate measurement of a percarboxylic acid concentration without manual work.

In addition, an object of the present invention is to provide a reagent to be used as an indicator solution in the method for quantifying a percarboxylic acid highly accurately according to the present invention. Furthermore, an object of the present invention is to provide a device that can measure the percarboxylic acid concentration of a percarboxylic acid-containing aqueous solution easily and accurately.

### Solution to Problem

The present inventors have extensively conducted studies for achievement of the above-described objects, and have confirmed that a blue dye called Brilliant Blue FCF has properties of (1) being soluble in water, (2) being stable in an aqueous solution without being affected by water or pH, (3) being unreactive with all of percarboxylic acids such as peracetic acid, iodide salts such as potassium iodide, and reaction products of a percarboxylic acid and an iodide salt, and (4) having a color development region that does not overlap with the color development region of a polyiodide ion as a reaction product of a percarboxylic acid and an iodide salt, and further confirmed that in the presence of the blue dye, a highly linear calibration curve can be drawn between the percarboxylic acid concentration and the absorbance of the reaction product (iodine) in at least a percarboxylic acid concentration range of 2000 mM or less by reacting a percarboxylic acid at various concentrations with a iodide salt, and thus found that the blue dye is useful as an internal standard substance in the KI method in which the iodide salt is used.

Then, the present inventors have confirmed that the percarboxylic acid concentration in a percarboxylic acid-containing aqueous solution can be calculated with high accuracy by adding the percarboxylic acid-containing aqueous solution to an iodide salt aqueous solution (indicator solution) to which the blue dye (internal standard substance) is added to react the percarboxylic acid with potassium iodide in the presence of the blue dye, then measuring the intensity (second light intensity) of transmitted light (or reflected light) at a wavelength of 440 to 600 nm, preferably 470 nm, derived from the reaction product (iodine) in the reaction liquid, and determining the percarboxylic acid concentration in the reaction liquid using the calibration curve, and in addition, measuring the intensity (first light intensity) of transmitted light (or reflected light) at a wavelength of 600 to 700 nm, preferably 630 nm, derived from the blue dye for each of the indicator solution before the reaction and the reaction liquid after the reaction, and from the resulting change, determining the amount (volume) of the added percarboxylic acid-containing aqueous solution or the mixing ratio between the added percarboxylic acid-containing aqueous solution and the indicator solution.

The present invention has been completed by further conducting studies based on these findings, and includes the following embodiments. Hereinafter, a percarboxylic acid may be referred to as a “PCA”, and Brilliant Blue FCF may be referred to as a “BB dye” or an “internal standard substance”.

### (I) Method for Measuring Percarboxylic Acid (PCA) Concentration

(I-1) A method for measuring a PCA concentration in a PCA-containing aqueous solution (test sample), the method including the steps of:
(1) mixing an aqueous solution (indicator solution) containing an iodide salt and a BB dye with a test sample to cause a reaction between a PCA and the iodide salt while the BB dye is present;
(2) measuring an intensity (first light intensity) of transmitted light or reflected light at a wavelength (first wavelength) in a wavelength range of 600 to 700 nm and an intensity (second light intensity) of transmitted light or reflected light at a wavelength (second wavelength) in a wavelength range of 440 to 600 nm for a solution (reaction liquid) after the reaction;
(3) calculating and determining a PCA concentration per total amount of the test sample and the indicator solution from the second light intensity obtained in the step (2) using a correlation of a second light intensity measured for a reaction liquid of a PCA-containing aqueous solution (standard sample) having a known PCA concentration and the indicator solution with a PCA concentration obtained by converting the known PCA concentration of the standard sample into a PCA concentration per total amount of the standard sample and the indicator solution, the known PCA concentration set to various known PCA concentrations; and
(4) measuring a first light intensity of the indicator solution used in the step (1), and calculating and determining a PCA concentration of the test sample from the PCA concentration per total amount of the test sample and the indicator solution determined in the step (3) on the basis of a difference from the first light intensity of the reaction liquid obtained in the step (2).
(I-2) The method according to (1-1), including, before the step (1), a step of measuring an intensity (first light intensity) of transmitted light or reflected light at the wavelength (first wavelength) in the wavelength range of 600 to 700 nm and/or an intensity (second light intensity) of transmitted light or reflected light at the wavelength (second wavelength) in the wavelength range of 440 to 600 nm for the aqueous solution (indicator solution) containing the iodide salt and the BB dye.
(I-3) The method according to (I-1), wherein the correlation used in (3) is represented by a calibration curve with one axis showing the second light intensity of the reaction liquid and the other axis showing the percarboxylic acid concentration.
(I-4) The method according to any one of (I-1) to (I-3), wherein the second wavelength is 470 nm, and/or the first wavelength is 630 nm.
(I-5) The method according to any one of (I-1) to (I-4), wherein the PCA is peracetic acid, and/or the iodide salt is potassium iodide.
(I-6) The method according to any one of (1-1) to (I-5), wherein a measurement solution (mixed liquid of the test sample and the indicator solution) prepared in the step (1) has a pH of 1 to 6, and preferably has a pH of 2 to 6.
(I-7) The method according to any one of (I-1) to (I-6), wherein the measurement solution prepared in the step (1) has a concentration of the PCA of 0.01 to 200 ppm.
(I-8) The method according to any one of (I-1) to (I-7), wherein the indicator used in the step (1) contains the iodide salt in an amount of 2 to 60 times the number of moles of the PCA in the measurement solution prepared in the step (1).
(I-9) The method according to any one of (I-1) to (I-8), wherein the PCA-containing aqueous solution to be measured is an equilibrium mixture containing the PCA and hydrogen peroxide.
(I-10) The method according to any one of (I-1) to (I-9), wherein the PCA-containing aqueous solution to be measured is a disinfectant or a bactericide.

### (II) Indicator Solution for Use in Measuring PCA Concentration

(II-1) An indicator solution to be used for measuring a PCA concentration in an aqueous solution (test sample) containing a PCA, the indicator solution containing: Brilliant Blue FCF (a BB dye) as an internal standard substance; and an iodide salt as a coloring substance.
(II-2) The indicator solution according to (II-1), wherein the PCA is peracetic acid, and/or the iodide salt is potassium iodide.
(II-3) The indicator solution according to (II-1) or (II-2), having a pH in a range of 1 to 6, preferably having a pH of 2 to 6.
(II-4) The indicator solution according to any one of (II-1) to (II-3), further containing at least one selected from the group consisting of pH adjusting agents, preservatives, stabilizers, and sequestering agents.
(II-5) The indicator solution according to any one of (II-1) to (II-4), containing 0.0000001 to 0.1 mass % of the BB dye and 0.01 to 1 mass % of the iodide salt.
(II-6) The indicator solution according to any one of (II-1) to (II-5), wherein the PCA-containing aqueous solution is an equilibrium mixture containing the PCA and hydrogen peroxide.
(II-7) The indicator solution according to any one of (II-1) to (II-6), wherein the PCA-containing aqueous solution is a disinfectant or a bactericide.

### (III) Device Capable of Measuring PCA Concentration in a PCA-Containing Aqueous Solution

(III-1) A device capable of measuring a PCA concentration in a PCA-containing aqueous solution (test sample), the device including:
(A) a measurement unit 1; and
(B) a determination unit 2,
(A) the measurement unit 1 including:
(a1) a sample container 11 that contains a measurement test liquid;
(a2) a light emitting unit 121 including a light source 12 that emits light at two wavelengths of a wavelength (first wavelength) in a wavelength range of 600 to 700 nm and a wavelength (second wavelength) in a wavelength range of 440 to 600 nm to the sample container 11 containing a measurement test liquid; and
(a3) a light receiving unit 131 including a light receiving element 13 that detects an intensity (light intensity) of transmitted light or reflected light of the light emitted from the light emitting unit 121, the transmitted light or the reflected light from the sample container 11,
the measurement test liquid being the indicator solution according to any one of (II-1) to (II-7) or a mixed liquid of the indicator solution and a test sample,
(B) the determination unit 2 including (b1) a storage unit 21 and (b2) an operation unit 22,
(b1) the storage unit 21 configured to store a correlation of a light intensity measured at the second wavelength for a reaction liquid of a PCA-containing aqueous solution (standard sample) having a known concentration and the indicator solution according to any one of (II-1) to (II-7) with a PCA concentration obtained by converting the known concentration of a PCA in the standard sample into a PCA concentration per total amount of the standard sample and the indicator solution,
(b2) the operation unit 22 configured to
(i) calculate a PCA concentration, for a reaction liquid of the test sample and the indicator solution contained in the sample container 11, converted per total amount of the test sample and the indicator solution in the measurement unit 1 on the basis of the correlation from the light intensity (I²_{fin}) measured at the second wavelength, and
(ii) determine a PCA concentration in the test sample on the basis of a difference between a light intensity (I¹ᵢₙᵢ) measured at the first wavelength for the indicator solution and a light intensity (I¹_{fin}) measured at the first wavelength for the reaction liquid of the indicator solution and the test sample, from the PCA concentration calculated in (i).
(III-2) The device capable of measuring a PCA concentration according to (III-1), further including (C) a liquid dispensing system 3 including:
a first chamber 31 that contains the indicator solution, and/or a second chamber 32 that contains the test sample; and
an indicator supply line 33 that delivers the indicator solution contained in the first chamber 31 to the sample container 11, and/or a test sample supply line 34 that delivers the test sample contained in the second chamber to the sample container 11.
(III-3) The device capable of measuring a PCA concentration according to (III-2), wherein the liquid dispensing system 3 further includes a liquid discharge line 35 that discharges the reaction liquid delivered to the sample container 11 outside the sample container 11.
(III-4) The device capable of measuring a PCA concentration according to (III-2) or (III-3), including a mixing chamber 36 that mixes the indicator solution and the test sample among the first chamber 31, the second chamber 32, and the sample container 11,
the mixing chamber configured so that to the mixing chamber 36, the indicator solution is delivered from the first chamber 31 through the indicator supply line 33 and the test sample is delivered from the second chamber 32 through the test sample supply line 34, separately, and a liquid mixed in the mixing chamber 36 is delivered to the sample container 11 through a liquid supply line 37.
(III-5) The device capable of measuring a PCA concentration according to any one of (III-1) to (III-4), wherein
the light source 12 includes a first light source 12-1 that emits light having a wavelength (first wavelength) in a wavelength range of 600 to 700 nm to the sample container 11 and a second light source 12-2 that emits light having a wavelength (second wavelength) in a wavelength range of 440 to 600 nm to the sample container 11, the first light source is a red light emitting diode (red LED) or a light emitting diode having a wavelength range including a wavelength range of 600 to 700 nm, and the second light source is a blue light emitting diode (blue LED) or a light emitting diode having a wavelength range including a wavelength range of 440 to 600 nm, and
the light receiving element is a photodiode.
(III-6) The device capable of measuring a PCA concentration according to any one of (III-1) to (III-5), wherein the PCA is peracetic acid, and/or the iodide salt is potassium iodide.

### Advantageous Effects of Invention

The method for measuring a PCA concentration of the present invention and the device capable of measuring a PCA concentration of the present invention enables correction of an error that may be caused by pipetting operation or the like, and enables highly accurate measurement and determination of the PCA concentration in a PCA-containing aqueous solution. Therefore, in the food hygiene field and the medical field, the PCA concentration, which requires strict concentration control, can be easily measured and managed in a disinfectant or a bactericide containing a PCA as an active ingredient, without dependence on the level of human skill.

### BRIEF DESCRIPTION OF DRAWINGS

FIG. 1 is a flowchart showing an outline of steps in a method for measuring a PCA concentration of the present invention.

FIG. 2 is an explanatory diagram schematically showing a main part of a device capable of measuring a PCA concentration 1 (cell fixed type) as an aspect of the device capable of measuring a PCA concentration of the present invention.

FIG. 3 is a flowchart showing an outline of a method in which a PCA-containing aqueous solution (standard sample) having a known concentration and an indicator are used for determining a correlation of a second light intensity of a reaction liquid of the standard sample and the indicator with a PCA concentration per total amount of the standard sample and the indicator.

FIG. 4 is an explanatory diagram schematically showing a main part of a device capable of measuring a PCA concentration 2 (flow cell type, intra-cell mixing) as an aspect of the device capable of measuring a PCA concentration of the present invention.

FIG. 5 is an explanatory diagram schematically showing a main part of a device capable of measuring a PCA concentration 3 (flow cell type, out-of-cell mixing) as an aspect of the device capable of measuring a PCA concentration of the present invention.

FIG. 6 shows absorption spectra of a BB dye solution (BB), a KI solution (KI), a BB indicator solution (BB+KI), and a solution obtained by adding a peracetic acid diluted solution to a BB dye solution (BB+PA) measured in Test Example 1.

FIG. 7 shows absorption spectra (of STB+PA1 to STB+PA5) obtained by adding different amounts of a peracetic acid diluted solution (0.1 to 0.5 ml) to a BB indicator solution (BB+KI: STB) (STB+PA0) and measured in Test Example 1.

FIG. 8 shows absorption spectra of a CV dye solution (CV, CV0), a KI solution (KI), a CV indicator solution (CV+KI), and a solution obtained by adding a peracetic acid diluted solution to a CV dye solution (CV+PA) measured in Test Example 1.

FIG. 9 shows absorption spectra (of STC+PA1 to STC+PA5) obtained by adding different amounts of a peracetic acid diluted solution (0.1 to 0.5 ml) to a CV indicator solution (CV+KI: STC) (STC+PA0) and measured in Test Example 1.

FIG. 10 shows a graph obtained by plotting the peracetic acid concentration in a measurement solution along the horizontal axis and the absorbance measured at a wavelength of 635 nm and a wavelength of 400 nm to 550 nm along the vertical axis on the basis of the absorption spectra in Fig. B in Test Example 2.

FIG. 11 shows a graph obtained by enlarging the scale of the vertical axis (absorbance) in Fig. E and plotting the peracetic acid concentration in a measurement solution along the horizontal axis and the absorbance measured at a wavelength of 470 nm to 700 nm along the vertical axis.

FIG. 12 shows a calibration curve of the peracetic acid concentration prepared in Test Example 3. The horizontal axis shows the peracetic acid concentration (mM), and the vertical axis shows the absorbance at a wavelength of 470 nm.

### DESCRIPTION OF EMBODIMENTS

### (I) Method for Measuring PCA Concentration, and Indicator Solution Used Therein

The present invention is a method for quantifying the PCA concentration in a PCA-containing aqueous solution by optically measuring a color derived from a product (iodine) generated by a reaction between the PCA and an iodide salt.

The measurement method of the present invention is first characterized by use of an aqueous solution containing an iodide salt as a coloring substance and Brilliant Blue FCF (a BB dye) as an internal standard substance, as an indicator solution used in a reaction with a PCA.

### (Indicator Solution)

Examples of the iodide salt used as a coloring substance in the indicator solution include potassium iodide, sodium iodide, and lithium iodide, and potassium iodide is preferable.

The Brilliant Blue FCF (BB dye) used as an internal standard substance in the indicator solution is a water-soluble blue dye (Blue No. 1) represented by the following formula.

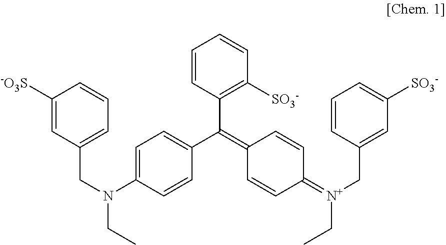

The indicator solution used in the method of the present invention is in a state in which the iodide salt and the BB dye are dissolved in water. The water is not limited as long as it does not affect the measurement of the present invention, and water such as purified water, pure water, or ion-exchanged water can be used.

The indicator solution may be prepared by dissolving the iodide salt and the BB dye in water immediately before the measurement of the present invention, or may be prepared in advance and contained in any container. Although not limited, the container may be filled with the indicator solution prepared in advance and accurately weighed out in a predetermined amount. Although not limited, the container is preferably usable as a cell for optical measurement of, for example, absorbance in a visible light region so that the container can be used as it is in optical measurement including absorbance measurement with, for example, a spectrophotometer and/or can be used in optical measurement after addition of a PCA-containing aqueous solution (test sample) to be measured in the container. Furthermore, the container is preferably a cell container with a detachable lid (cap) so that the container can be transferred. The shape of the cell is not limited as long as optical measurement can be performed, and examples of the shape include a cubic shape, a plate shape, and the like. The container filled with the indicator solution is preferably shielded from light or packed in a light-shielding bag so as not to be affected by light during storage.

The concentration of the iodide salt in the indicator solution is to be a concentration at which the iodide salt mixed with a PCA-containing aqueous solution can react with a PCA in the PCA-containing aqueous solution to generate iodine. The amount of the iodide salt in the mixed liquid (measurement solution) of the indicator solution and the PCA-containing aqueous solution is desirably 2 to 60 times, preferably 3 to 30 times, and more preferably 3 to 15 times the number of moles of the PCA. If the amount of the iodide salt is less than 2 times the number of moles of the PCA, the amount necessary for the reaction with the PCA is not met. Meanwhile, if the amount of the iodide salt is more than 60 times the number of moles of the PCA, for example, in the case of a PCA-containing aqueous solution containing hydrogen peroxide, the hydrogen peroxide reacts with the iodide salt to generate iodine, and the amount of iodine gradually increases, so that an accurate PCA concentration tends to be difficult to obtain. In consideration of the above, the concentration of the iodide salt in the indicator solution can be set. To this extent, although not limited, the concentration of the iodide salt in the indicator solution can be usually 0.005 to 2 mass %. The concentration is preferably 0.01 to 1 mass %, and more preferably 0.02 to 0.5 mass %.

The concentration of the BB dye in the indicator solution is to be a concentration at which the absorbance at a wavelength of 630 nm is in the range of 0.001 to 3 at least at the time of measurement (before mixing of the percarboxylic acid aqueous solution). The concentration is not limited, and for example, can be 0.0000001 to 0.1 mass %. The concentration is preferably 0.000001 to 0.01 mass %, and more preferably 0.00001 to 0.005 mass %.

When the indicator solution is mixed with the PCA-containing aqueous solution, the pH of the mixed liquid (measurement solution) is preferably controlled so as to be in the range of 1 to 6, preferably 2 to 6, and more preferably 3 to 5. If the pH of the measurement solution is 6 or more, the amount of iodine generated gradually decreases, and if the pH is 1 or less, for example, in the case of a PCA-containing aqueous solution containing hydrogen peroxide, the hydrogen peroxide reacts with the iodide salt to generate iodine, and the amount of iodine gradually increases, so that an accurate PCA concentration tends to be difficult to obtain.

Therefore, the indicator solution desirably contains a pH adjusting agent to have a pH adjusted in the range of 1 to 6, preferably 2 to 6, and more preferably 3 to 5 at least when mixed with the PCA-containing aqueous solution. Examples of the pH adjusting agent for this purpose include, but are not limited to, organic or inorganic acids such as citric acid, succinic acid, gluconic acid, tartaric acid, lactic acid, malic acid, and phosphoric acid, and salts thereof as long as an object of the present invention (quantification of a PCA concentration with high accuracy) is not impaired. The pH adjusting agent is preferably citric acid.

The indicator solution may contain a preservative or a stabilizer in addition to the iodide salt, the BB dye, and, as necessary, the pH adjusting agent as long as an object of the present invention (quantification of a PCA concentration with high accuracy) is not impaired. Examples of such a preservative include, but are not limited to, acid type preservatives such as benzoates, phenoxyethanol, and parabens. Examples of the stabilizer include, but are not limited to, water-soluble solvents such as ethanol, glycerin, and propylene glycol, and water-soluble polymers such as polyacrylic acid and a maleic acid/acrylic acid copolymer.

The PCA that can be quantified with the method of the present invention is to be a PCA that reacts with the iodide salt contained in the indicator solution, particularly potassium iodide, to generate iodine rapidly. As long as the PCA is as described above, examples of the PCA preferably include, but are not particularly limited to, peracetic acid. Peracetic acid is a bactericidal agent that requires concentration control (precise quantification) strongly in order to ensure its bactericidal action.

The measurement method of the present invention is secondly characterized by using two wavelengths of an absorption wavelength (hereinafter, also referred to as “first wavelength”) derived from the BB dye used as an internal standard substance (hereinafter, sometimes abbreviated as “internal standard substance”) and an absorption wavelength (hereinafter, also referred to as “second wavelength”) derived from iodine (reaction product) generated by a reaction between the PCA and the iodide salt and measuring the intensity of transmitted light or reflected light (collectively referred to as “light intensity” without distinguishing the light) at each wavelength (a two-wavelength absorption measurement method).

The first wavelength needs to be a wavelength at which absorption derived from the BB dye (internal standard substance) can be measured, and a wavelength that does not overlap with the absorption wavelengths of the PCA, the iodide salt, and a reaction product thereof. Examples of such a wavelength include a wavelength in the visible range of 600 to 700 nm. The wavelength is preferably in the range of 600 to 650 nm, and more preferably 630 nm.

The second wavelength needs to be a wavelength at which absorption derived from iodine can be measured, and a wavelength that does not overlap with the absorption wavelengths of the PCA, the iodide salt, and the internal standard substance. Examples of such a wavelength include a wavelength in the visible range of 440 to 600 nm. This is because at a wavelength of shorter than 440 nm, the peak overlaps with the peak of a polyiodide ion having an absorption maximum around 350 nm, and at a wavelength of longer than 600 nm, absorption is so weak that an accurate percarboxylic acid concentration is difficult to obtain. The wavelength is preferably in the range of 440 to 500 nm, and more preferably 470 nm.

The amount of the reaction product (iodine) can be determined by mixing the PCA-containing aqueous solution with the indicator solution (preparation of a reaction liquid), reacting the PCA with the iodide salt, and then measuring the light intensity of the reaction liquid using the second wavelength. The light intensity derived only from the reaction product can be measured by measuring the light intensity of the PCA-containing aqueous solution and/or the indicator solution in advance using the second wavelength (blank measurement) and correcting the zero point using the obtained light intensity. In the present invention, the light intensity measured using the second wavelength is also referred to as “second light intensity” or “I²” for convenience. In particular, the second light intensity measured for the reaction liquid may be referred to as “I²_{fin}”, and the second light intensity measured for the indicator solution may be referred to as “I²ᵢₙᵢ”.

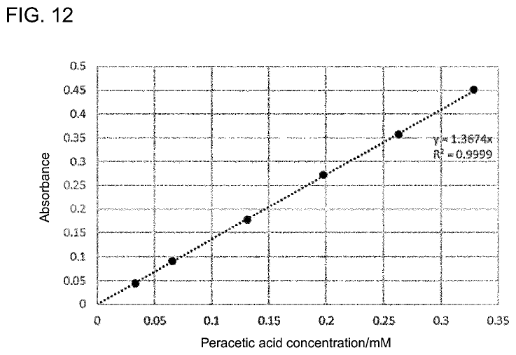

There is a good correlation of the second light intensity (I²_{fin}) obtained for the reaction liquid of the PCA-containing aqueous solution and the indicator solution with the PCA concentration of the PCA-containing aqueous solution. There is also a good correlation of the PCA concentration obtained by converting the PCA concentration of the PCA-containing aqueous solution into the PCA concentration per total amount of the PCA-containing aqueous solution and the indicator solution with the second light intensity of the reaction liquid (see Test Example 3 and FIG. 12).

Therefore, the percarboxylic acid concentration per total amount of the test sample and the indicator solution can be calculated from the second light intensity (I²_{fin}) measured for the reaction liquid of the PCA-containing aqueous solution (test sample) having an unknown concentration and the indicator solution on the basis of a correlation determined as follows. Using PCA-containing aqueous solutions (standard samples) containing the PCA in various known amounts, a correlation of the second light intensity (I²_{fin}) of a reaction liquid obtained by reacting a standard sample and the indicator solution with the PCA concentration per total amount of the standard sample and the indicator solution converted from the known amount is determined in advance, and stored as a calibration curve formula or the like.

In addition, the first wavelength is used for measuring the light intensity of the indicator solution used for the reaction with the PCA-containing aqueous solution (test sample) having an unknown concentration, and thus the concentration of the internal standard substance in the indicator solution can be determined. Similarly, the first wavelength is used for measuring the light intensity of the reaction liquid of the test sample and the indicator solution, and thus the concentration of the internal standard substance in the reaction liquid can be determined. Hereinafter, the light intensity measured using the first wavelength is also referred to as “first light intensity” or “I¹” for convenience. In particular, the first light intensity measured for the indicator solution may be referred to as “I¹ᵢₙᵢ”, and the first light intensity measured for the reaction liquid may be referred to as “I¹_{fin}”.

The volume difference between the reaction liquid and the indicator solution, that is, the amount (volume) of the added PCA-containing aqueous solution mixed with the indicator solution can be calculated from the difference between the first light intensity (I¹ᵢₙᵢ) reflecting the internal standard substance concentration of the indicator solution and the first light intensity (I¹_{fin}) reflecting the internal standard substance concentration of the reaction liquid, for example, the difference (I¹ᵢₙᵢ−I¹_{fin}). Furthermore, the ratio (mixing ratio) between the indicator solution and the PCA-containing aqueous solution added to and mixed with the indicator solution can be calculated from the ratio between the first light intensity (I¹ᵢₙᵢ) of the indicator solution and the first light intensity (I¹_{fin}) of the reaction liquid.

At the time of measurement, if the amount of the indicator solution is determined in advance, for example, as in the case of using a container type cell containing the indicator solution, the amount of the PCA-containing aqueous solution (test sample) added to the indicator solution and the total amount thereof can be accurately calculated from the difference. Therefore, the PCA concentration in the test sample can be calculated from the PCA concentration per total amount of the test sample and the indicator solution calculated in advance from the second light intensity (I²_{fin}) of the reaction liquid on the basis of the correlation.

As described above, in the measurement method of the present invention,
the second light intensity (I²_{fin}) of the reaction liquid of the PCA-containing aqueous solution (test sample) having an unknown concentration and the indicator solution is measured using the second wavelength derived from the reaction product (iodine) of the PCA and the iodide salt, the PCA concentration per total amount of the test sample and the indicator solution is calculated on the basis of the correlation prepared in advance,
the first light intensity (I¹ᵢₙᵢ) of the indicator solution and the first light intensity (I¹_{fin}) of the reaction liquid are measured using the first wavelength derived from the internal standard substance, the difference between the first light intensity (I¹ᵢₙᵢ) of the indicator solution and the first light intensity (I¹_{fin}) of the reaction liquid is calculated, and then
the PCA concentration of the test sample itself is calculated on the basis of the difference, from the PCA concentration per total amount of the test sample and the indicator solution.

In such a method, if the amount of the indicator solution is accurately weighed, the amount of the test sample added to the indicator solution can be corrected even in a case where the amount of the test sample varies, and the PCA concentration in the test sample can be accurately determined. Furthermore, if the concentration of the internal standard substance in the indicator solution is determined, the mixing ratio between the test sample and the indicator solution can be calculated from the difference between the first light intensity (I¹ᵢₙᵢ) and (I¹_{fin}) even in a case where the mixing ratio varies, and the PCA concentration in the test sample can be accurately determined using the mixing ratio. Although not limited, the former method can be used, for example, in the case of using a fixed cell, such as a container type cell containing an indicator solution, for measuring the light intensity, and the latter method can be used, for example, in the case of using a flow cell type cell for measuring the light intensity. A flow cell type cell has a constant optical path length, and therefore the mixing ratio between the indicator solution and the test sample can be determined from the difference between the first light intensity (I¹ᵢₙᵢ) when the indicator solution having a predetermined concentration flows and the first light intensity (I¹_{fin}) when the reaction liquid of the indicator solution and the test sample flows in the flow cell type cell, and conversion can be performed from the mixing ratio.

In the measurement method of the present invention, the measurement solution (indicator solution+PCA containing aqueous solution) preferably has a PCA concentration of 0.01 to 200 ppm. The PCA concentration is more preferably 0.1 to 100 ppm, and still more preferably 1 to 50 ppm. The amount of the PCA-containing aqueous solution to be added to the indicator solution is preferably adjusted appropriately so as to be within the above-described range of concentration.

The light intensity of the indicator solution and the reaction liquid at each wavelength can be measured using a spectrophotometer capable of measuring the intensity of transmitted light or reflected light at least in an absorption region (360 to 830 nm) of visible light. The light intensity can also be measured using an instrument having a measurement unit capable of measuring the absorbance. The instrument is preferably a spectrophotometer or a measuring instrument set to be capable of measuring the light intensity at two wavelengths of the first wavelength and the second wavelength described above at the same time or different times, and including a light source and a light receiving element that receives transmitted light or reflected light of light emitted from the light source. The number of light sources may be one or two or more as long as the above-described setting can be realized. For example, the light source may include two light sources of a first light source that emits light having a first wavelength and a second light source that emits light having a second wavelength. Alternatively, one light source that emits light having a wide wavelength range including at least a range of 440 to 700 nm can be used, and the light can be diffracted to the first wavelength and the second wavelength using a filter or the like before and after transmission/reflection.

The light source can be a light emitting diode (LED). In the case of using two light sources, an LED that emits light at a wavelength in the range of 600 to 650 nm, which is the first wavelength, can be used as one light source (LED) (first light source). Examples of the light source include, but are not limited to, a red LED made of InGaAlP or GaP. As another light source (LED) (second light source), an LED that emits light at a wavelength in the range of 430 to 600 nm, which is the second wavelength, can be used. Examples of the light source include, but are not limited to, a blue LED made of InGaN. In the case of using one light source, a white LED is used, and the light is diffracted to the first wavelength and the second wavelength using a filter or the like before and after transmission/reflection, and used. In the case of using an LED as the light source, the device capable of measuring a PCA concentration (device) can also be small and inexpensive by using an aspect in which light emitted from the LED and transmitted or reflected by the test sample is detected by a photodiode as the light receiving element.

The measurement method of the present invention is thirdly characterized by including at least two light intensity measuring steps of measuring the light intensity of the indicator solution at the first wavelength as first measurement, and measuring the light intensity (the first light intensity and the second light intensity) at each of the first wavelength and the second wavelength after mixing of the indicator solution and the PCA-containing aqueous solution (test sample).

In the first measurement, the indicator solution may be provided in a state of being contained in advance in a container type cell to be subjected to light intensity measurement, or may be automatically put into an empty container type cell (a cubic cell having a fixed optical path length, a plate cell having a fixed bottom area, and the like are included in examples of the cell) with a device and thus provided.

Prior to the second measurement, a PCA-containing aqueous solution (test sample) is manually or automatically added in a container type cell containing the indicator solution and mixed in the cell. The mixing may be performed in the manner of, for example, using a rotor and a stirrer, or may be automatically performed with a mechanical device.

The cell to be subjected to the light intensity measurement is not limited to a container type cell, and may be a flow cell or a cylindrical cell. The cell to be used is preferably made of a material having chemical resistance and not affecting transmission or reflection of light at the first wavelength and the second wavelength. Examples of the cell include cells made of glass, an acrylic resin, a polycarbonate resin, vinyl chloride, and a PET resin.

The first measurement and the second measurement described above can be performed, for example, as follows according to the type and shape of the cell to be used and the kind of the light to be measured (transmitted light and reflected light).

### [Container Type Cell: Cubic Cell]

(1) Use of transversely transmitted light: The side of a cubic container type cell containing the indicator solution is irradiated with light at the first wavelength, and the intensity (light intensity) of the light transmitted transversely is measured (first measurement), and subsequently, the PCA-containing aqueous solution is put into the cell and mixed, then the side of the cell is similarly irradiated with light at the first wavelength and the second wavelength, and the light intensity of each transmitted light is measured (second measurement).
(2) Use of transversely reflected light: The side of a cubic container type cell containing the indicator solution is irradiated with light at the first wavelength, and the intensity of the light reflected from the cell wall surface transversely is measured (first measurement), and subsequently, the PCA aqueous solution is put into the cell and mixed, then the side of the cell is similarly irradiated with light at the first wavelength and the second wavelength, and the light intensity of each reflected light is measured (second measurement).

### [Container Type Cell: Plate Cell]

(3) Use of longitudinally transmitted light: The bottom (or the top) of a plate container type cell containing the indicator solution is irradiated with light at the first wavelength, and the intensity (light intensity) of the light transmitted longitudinally is measured (first measurement), and subsequently, the PCA-containing aqueous solution is put into the cell and mixed, then the bottom or the top of the cell is similarly irradiated with light at the first wavelength and the second wavelength, and the light intensity of each transmitted light is measured (second measurement).
(4) Use of longitudinally reflected light: The bottom (or the top) of a plate container type cell containing the indicator solution is irradiated with light at the first wavelength, and the intensity (light intensity) of the light reflected from the cell wall surface longitudinally is measured (first measurement), and subsequently, the PCA-containing aqueous solution is put into the cell and mixed, then the bottom or the top of the cell is similarly irradiated with light at the first wavelength and the second wavelength, and the light intensity of each reflected light is measured (second measurement).

### [Flow Cell]

(5) Use of transmitted light: The indicator solution flowing in a flow cell is irradiated with light at the first wavelength from the side, and the intensity (light intensity) of the light transmitted transversely is measured (first measurement), and subsequently, the mixed liquid of the indicator solution and the PCA-containing aqueous solution flowing in the flow cell is similarly irradiated with light at the first wavelength and the second wavelength, and the light intensity of each transmitted light is measured (second measurement).
(6) Use of reflected light: The indicator solution flowing in a flow cell is irradiated with light at the first wavelength from the side, and the intensity (light intensity) of the light reflected from the wall surface is measured (first measurement), and subsequently, the mixed liquid of the indicator solution and the PCA-containing aqueous solution flowing in the flow cell is similarly irradiated with light at the first wavelength and the second wavelength, and the light intensity of each reflected light is measured (second measurement).

### [Cylindrical Cell]

(7) Use of transmitted light: The indicator solution flowing in a cylindrical cell is irradiated with light at the first wavelength from the side, and the intensity (light intensity) of the light transmitted transversely is measured (first measurement), and subsequently, the mixed liquid of the indicator solution and the PCA-containing aqueous solution flowing in the flow cell is similarly irradiated with light at the first wavelength and the second wavelength, and the light intensity of each transmitted light is measured (second measurement).

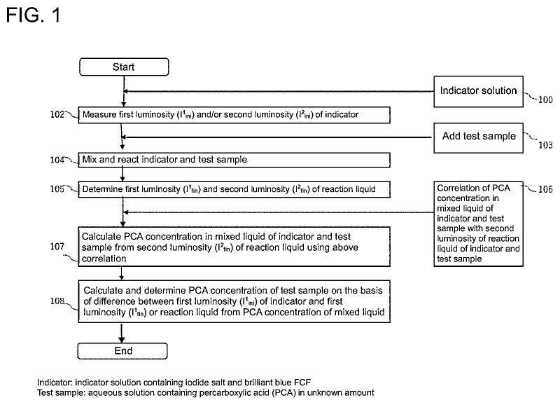

The measurement method of the present invention described above can be performed, for example, in the following steps. FIG. 1 shows a schematic flowchart of the steps.
(1) A step of mixing an indicator solution with a test sample to cause a reaction between a PCA and an iodide salt while a BB dye is present (step 104 in FIG. 1),
(2) a step of measuring an intensity (first light intensity) of transmitted light or reflected light at a first wavelength and an intensity (second light intensity) of transmitted light or reflected light at a second wavelength for a solution (reaction liquid) after the reaction (step 105 in FIG. 1),
(3) a step of calculating and determining a PCA concentration per total amount of the test sample and the indicator solution from the second light intensity obtained in the step (2) (step 107 in FIG. 1) using a correlation of a second light intensity measured for a reaction liquid of a PCA-containing aqueous solution (standard sample) having a known PCA concentration and the indicator solution with a PCA concentration obtained by converting the known percarboxylic acid concentration of the standard sample into a PCA concentration per total amount of the standard sample and the indicator solution, the known PCA concentration set to various known PCA concentrations (step 106 in FIG. 1), and
(4) a step of measuring a first light intensity of the indicator solution used in the step (1), and calculating and determining a PCA concentration of the test sample from the PCA concentration per total amount of the test sample and the indicator solution determined in the step (3) on the basis of a difference from the first light intensity of the reaction liquid obtained in the step (2) (step 108 in FIG. 1).

The present invention can also include, before the step (1), a step of measuring an intensity (first light intensity) of transmitted light or reflected light at the first wavelength and/or an intensity (second light intensity) of transmitted light or reflected light at the second wavelength for the indicator solution (step 102 in FIG. 1).

Note that these series of steps may be performed manually by a human using a spectrophotometer, but can also be performed automatically using a device.

### (II) Device Capable of Measuring a PCA Concentration and Method of Using the Same

A device capable of measuring a PCA concentration will be described that is used for carrying out the measurement method of the present invention. However, the device described below is merely an example, and the measurement method of the invention can be carried out without being bound by the device described below.

The device capable of measuring a PCA concentration of the present invention can be used to measure the concentration of a PCA contained in a disinfectant or a bactericide containing a percarboxylic acid (PCA), preferably peracetic acid, as a bactericidal component, with high accuracy and convenience automatically or semi-automatically.

### [Device Capable of Measuring a PCA Concentration 1]

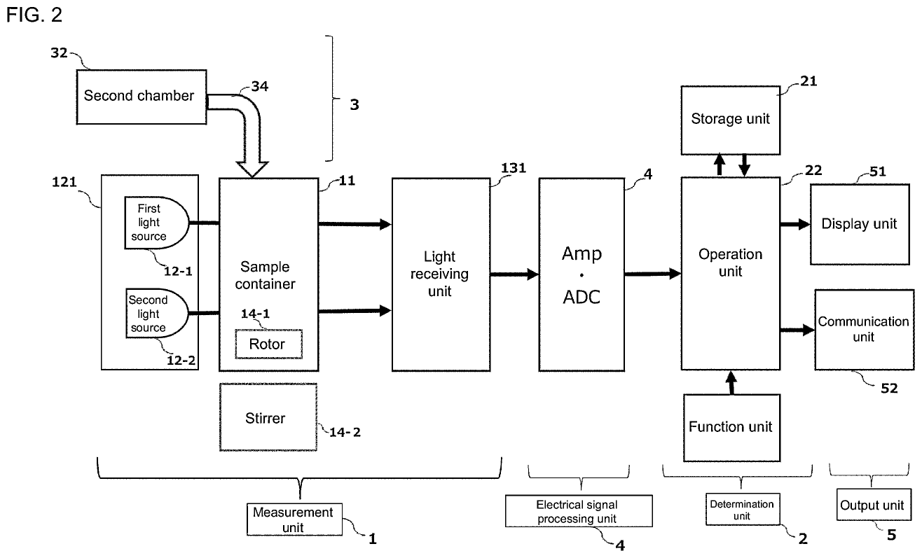

As an aspect of the device of the present invention, a device (device capable of measuring a PCA concentration 1) in which a measurement sample is put into a fixed cell and measured will be described with reference to FIG. 2. FIG. 2 is an explanatory diagram schematically showing a main part of the device 1. The device 1 has a form in which a cell (incorporating a rotor) containing an indicator solution is set in a sample container of the device, a test sample is added in the cell, the resulting mixture is stirred using a stirrer provided in the vicinity of the cell to cause a reaction, measurement is performed after the reaction, and then the entire cell is taken out from the sample container. In FIG. 2, an aspect is described in which the test sample is automatically or semi-automatically added in the cell contained in a sample container 11, but the present invention is not limited thereto. Instead of this aspect, the present invention may have an aspect, for example, in which a cell containing an indicator solution or a reaction liquid of the indicator solution and a test sample is set in the sample container 11 and used, or an aspect in which the indicator solution and the test sample are manually added in the cell contained in the sample container 11 and mixed in the cell.

As shown in FIG. 2, the device 1 includes a measurement unit 1 and a determination unit 2 as main components of the device 1.

The measurement unit 1 includes the sample container 11 that contains a measurement test liquid, a light emitting unit 121 including a first light source 12-1 that emits light having a wavelength (first wavelength) in a wavelength range of 600 to 700 nm to the sample container 11 containing a measurement test liquid and a second light source 12-1 that emits light having a wavelength (second wavelength) in a wavelength range of 440 to 600 nm to the sample container 11, and a light receiving unit 131 including a light receiving element 13 that detects intensity (light intensity) of transmitted light or reflected light from the sample container 11 irradiated with light.

The sample container 11 has a shape, a material, and a structure such that the above-described container type cell can be contained in the sample container 11 and light emitted from the light emitting unit 121 can be transmitted to the measurement sample in the cell. The measurement sample can be added in the container type cell in advance, or can be added in the empty container type cell after the empty container type cell is contained in the sample container 11. An aspect is preferable in which the container type cell containing an indicator solution in advance is contained in the sample container 11, then a test sample is added to flow into the container type cell from a second chamber 32 described below, and both the solutions are mixed in the cell. In FIG. 2, the cell is contained in the sample container 11 (not illustrated).

The light emitting unit 121 and the light receiving unit 131 are arranged to face each other with the sample container 11 interposed therebetween. The light emitting unit 121 emits light at the first wavelength and the second wavelength to the measurement sample in the cell contained in the sample container 11, with the first light source 12-1 and the second light source 12-2 (light emitting elements) included in the light emitting unit 121, respectively. These light sources 12 are arranged in parallel with the longitudinal axis of the sample container 11. These light sources 12 can be preferably constituted by light emitting diodes (LED) that emit light having respective wavelengths. For example, the first light source 12-1 can be a red LED that emits light having the first wavelength, and the second light source 12-2 can be a blue LED that emits light having the second wavelength. The light receiving unit 131 receives light emitted from the light emitting unit 121 and transmitted through the sample container 11, the cell, and the measurement sample. For example, in a case where the light source is an LED, the light receiving unit 131 can include the light receiving element 13 constituted by a photodiode. The light receiving element 13 is preferably arranged in parallel with the longitudinal axis of the sample container 11 to receive transmitted light from each of the first light source 12-1 and the second light source.

To the light receiving unit 131, an electrical signal processing unit 4 is connected that is configured to measure an electrical signal (for example, a voltage change) generated when light transmitted through the measurement sample is received, and amplify the electrical signal using, for example, an operational amplifier (Amp) and/or convert the analog electrical signal into a digital electrical signal using, for example, an A/D converter, and measurement processing data in the electrical signal processing unit 4 is input as a signal to the determination unit 2.

The determination unit 2 is a computer that operates in accordance with a program, and includes at least a storage unit 21 and an operation unit 22. The storage unit 21 and the operation unit 22 are connected so as to be capable of exchanging a signal with each other. The storage unit 21 stores, for each of PCA-containing aqueous solutions (standard samples) having different concentrations, electrically processed data corresponding to the second light intensity measured for a solution (reaction liquid) obtained by reacting the standard sample with an indicator solution, and correlation data (calibration curve data and the like) with a PCA concentration obtained by converting the PCA concentration in the standard sample into the PCA concentration per total amount of the standard sample and the indicator solution, in a manner such that the data can be read out. In the measurement flow, the storage unit 21 may be configured to temporarily store the electrical processing results corresponding to the first light intensity (I¹ᵢₙᵢ) and the second light intensity (I²ᵢₙᵢ) measured for the indicator solution, or the difference (difference or ratio) between the first light intensity (I¹ᵢₙᵢ) and the second light intensity (I²ᵢₙᵢ), in a state of being able to be read out. The storage unit 21 is to be connected so as to be capable of exchanging a signal with the operation unit 22 at the time of measurement, and may be an external memory.

When electrically processed data corresponding to the first light intensity (I¹ᵢₙᵢ) and the second light intensity (I²ᵢₙᵢ) of the indicator solution measured in the measurement unit 1 and the electrically processed data corresponding to the first light intensity (I¹_{fin}) and the second light intensity (I²_{fin}) of the reaction liquid of the test sample and the indicator solution are input as signals to the operation unit 22 via the electrical signal processing unit 4, the PCA concentration in the test sample can be calculated and determined by performing a predetermined arithmetic operation with the correlation data stored in the storage unit 21.

The PCA concentration (measurement result) thus obtained may be output via a medium such as a display unit 51 such as a display of the device 1, a communication unit 52 such as the Internet, or a recording unit (not illustrated) such as a printer (output unit 5).

The device 1 includes the second chamber 32 that contains a PCA-containing aqueous solution (test sample), and a test sample supply line 34 that supplies a test sample contained in the second chamber 32 into a cell contained in the sample container 11. Through the test sample supply line 34, the test sample contained in the second chamber 32 is supplied and added to an indicator solution in the cell contained in the sample container 11. The test sample supply line 34 is configured to supply a predetermined amount of the test sample into the cell automatically or semi-automatically with, for example, a pump (not illustrated). When the test sample is supplied and added into the cell, the indicator solution and the test sample are well stirred with a rotor 14-1 set in the cell and a stirrer 14-2 provided in the vicinity of the cell, and an iodide salt and a PCA in the test sample react with each other in the presence of an internal standard substance (BB dye) in the indicator solution, and thus a reaction liquid is obtained in which a color is developed according to the concentration of generated iodine (in other words, PCA concentration in the test sample).

The PCA concentration in the test sample can be measured using the device 1 in accordance with the schematic flowchart shown in FIG. 1. The outline is as follows although this is an example.
(0) First, a container type cell containing an indicator solution is set in the sample container 11, light having the first wavelength and light having the second wavelength are emitted from the first light source 12-1 and the second light source 12-2, and thus the first light intensity (I¹ᵢₙᵢ) and the second light intensity (I²ᵢₙᵢ) of the indicator solution are measured. These luminosities are processed in the electrical signal processing unit 4, then transmitted to the operation unit 22, and temporarily stored in the storage unit 21.
(1) Subsequently, the indicator solution and a test sample are mixed in the cell, and a PCA and an iodide salt are reacted in the presence of a BB dye to prepare a reaction liquid.
(2) The reaction liquid in the cell is irradiated with light having the first wavelength and light having the second wavelength, and thus the first light intensity (I¹_{fin}) and the second light intensity (I²_{fin}) of the reaction liquid are measured. These luminosities are processed in the electrical signal processing unit 4, and then transmitted to the operation unit 22.
(3) The PCA concentration of the test sample is calculated as the PCA concentration per total amount of the test sample and the indicator solution using the correlation data stored in the storage unit 21 from the electrical signal corresponding to the second light intensity (I²_{fin}) transmitted to the operation unit 22.
(4) The difference between the second light intensity (I²_{fin}) and the first light intensity (I¹ᵢₙᵢ) is determined from the electrical signal corresponding to the second light intensity (I₂^{fin}) transmitted to the operation unit 22 and the electrical signal corresponding to the first light intensity (I¹ᵢₙᵢ) of the indicator solution temporarily stored in the storage unit 21, and from the above PCA concentration, the PCA concentration of the test sample is calculated and determined on the basis of the difference. Then, the result is output to the outside via the output unit 5.

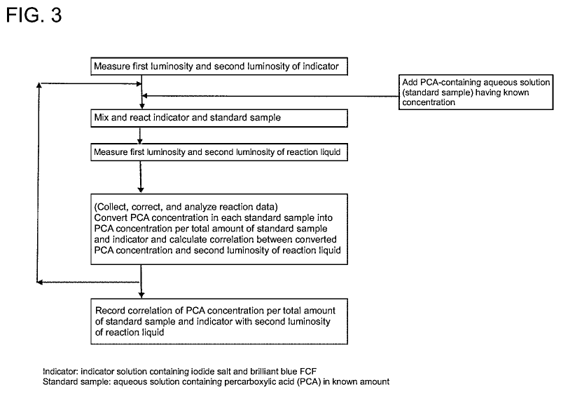

As shown in FIG. 3, the correlation data used in (3) above can be prepared by measuring the second light intensity (I²_{fin}) for a plurality of reaction liquids obtained by reacting each of PCA-containing aqueous solutions (standard samples) having various known concentrations with the indicator solution using the measuring device in advance, and acquiring the correlation between the second light intensity (I²_{fin}) and the PCA concentration obtained by converting the PCA concentration in the standard sample into the PCA concentration per total amount of the standard sample and the indicator solution. At this time, the first light intensity (I¹ᵢₙᵢ) and the second light intensity (I²ᵢₙᵢ) of the indicator solution and the first light intensity (I¹ᵢₙᵢ) of the reaction liquid can be used for blank correction (zero point correction) of the second light intensity (I²_{fin}).

### [Device Capable of Measuring a PCA Concentration 2]

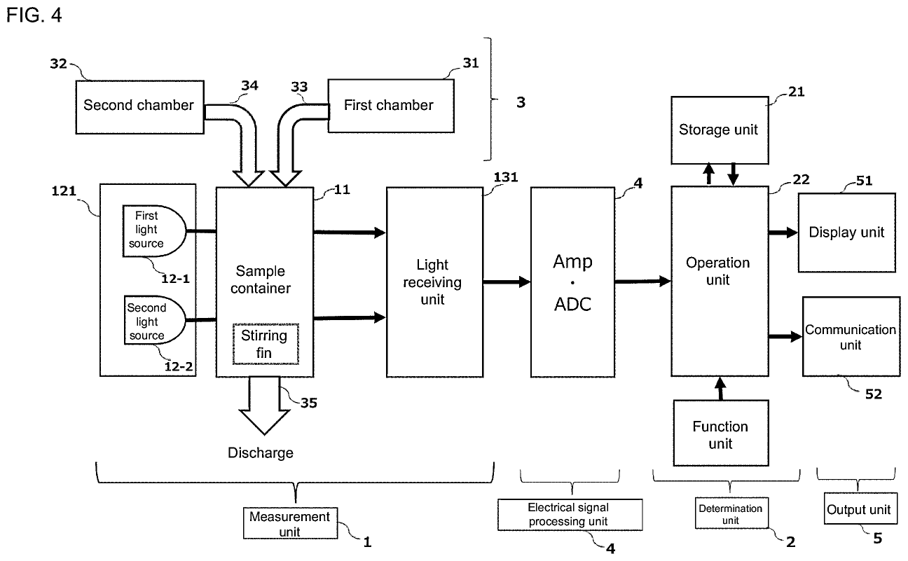

As another aspect of the device of the present invention, FIG. 4 shows an outline of a main part of a device (device capable of measuring a PCA concentration 2) in which a measurement sample is put into a flow cell, reacted in the cell, and then measured. The device 2 has a form in which an indicator solution and a test sample separately flow into the flow cell, then the mixture is stirred and reacted using a stirring fin in the cell, and then after the reaction liquid is measured, the reaction liquid is discharged from the flow cell via a liquid discharge line. In FIG. 4, the cell is contained in the sample container 11 (not illustrated).

As shown in FIG. 4, the device 2 includes a measurement unit 1 and a determination unit 2 as main components, and in addition, differing from the device 1, includes a first chamber 31 that contains an indicator solution, and an indicator supply line 33 that supplies the indicator solution contained in the first chamber 31 into a cell contained in the sample container 11. In addition, the device 2 includes a liquid discharge line 35 that discharges the reaction liquid reacted in the flow cell to the outside of the sample container 11.

The method for measuring a PCA concentration of a test sample using the device 2 is different from the measurement method using the device 1 in the following points.

First, through the indicator supply line 33, the indicator solution contained in the first chamber 31 is supplied into an empty flow cell arranged in the sample container 11. After the first light intensity (I¹ᵢₙᵢ) and the second light intensity (I¹_{fin}) of the indicator solution are measured, the test sample contained in the second chamber 32 is supplied through the test sample supply line 34 into the flow cell in which the indicator solution remains to be supplied. Both the solutions joined in the flow cell are stirred using a stirring fin and thus reacted to develop a color according to the concentration of the reaction product (iodine). After the first light intensity (I¹ᵢₙᵢ) and the second light intensity (I¹_{fin}) are measured in the sample container 11, the reaction liquid is discharged to the outside of the sample container 11. The device 2 includes the liquid discharge line 35 for the discharge.

### [Device Capable of Measuring a PCA Concentration 3]

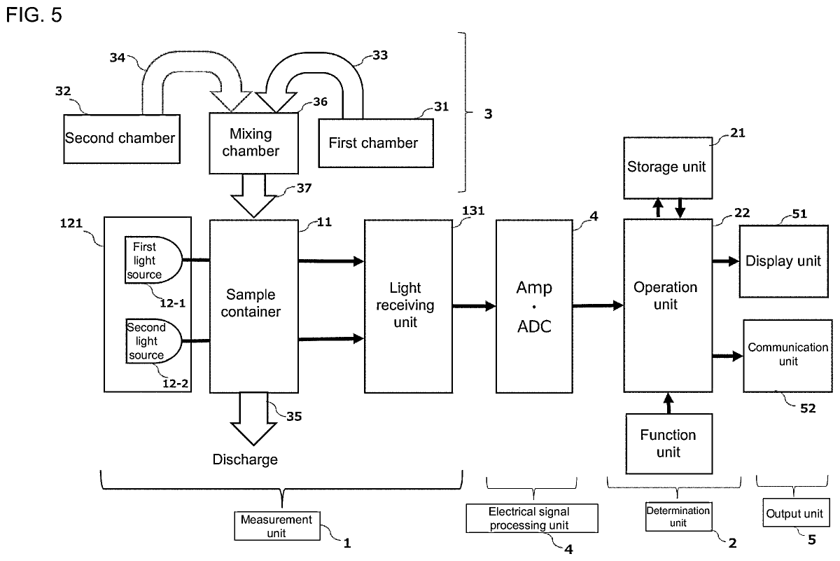

As another aspect of the device of the present invention, FIG. 5 shows an outline of a main part of a device (device capable of measuring a PCA concentration 3) in which a measurement sample is reacted, then put into a flow cell, and measured. The device 3 has a form in which an indicator solution and a test sample are mixed and reacted, and then the reaction liquid flows into the flow cell, and after measurement, the reaction liquid is discharged from the flow cell via a liquid discharge line. In FIG. 5, the cell is contained in the sample container 11 (not illustrated).

As shown in FIG. 5, the device 3 includes a measurement unit 1 and a determination unit 2 as main components, and in addition, differing from the device 2, includes a mixing chamber 36 in which an indicator solution supplied from a first chamber 31 through an indicator supply line 33 and a test sample supplied from a second chamber 32 through a test sample supply line 34 are mixed, and a liquid supply line 37 that supplies a reaction liquid mixed in the mixing chamber 36 to the sample container 11.

The method for measuring a PCA concentration of a test sample using the device 3 is different from the measurement method using the device 1 or 2 in the following points.

First, the indicator solution contained in the first chamber 31 is supplied through the indicator supply line 33, the mixing chamber 36, and the liquid supply line 37 into an empty flow cell arranged in the sample container 11, and the first light intensity (I¹ᵢₙᵢ) and the second light intensity (I¹_{fin}) of the indicator solution are measured. The indicator solution is then discharged to the outside of the sample container 11. The device 3 includes a liquid discharge line 35 for the discharge. Next, the indicator solution contained in the first chamber 31 and a test sample contained in the second chamber 32 are supplied through the indicator supply line 33 and the test sample supply line 34, respectively, to the mixing chamber 36, and both the liquids are mixed and reacted in the mixing chamber 36. The reaction liquid is colored according to the concentration of the reaction product (iodine). After the first light intensity (I¹ᵢₙᵢ) and the second light intensity (I¹_{fin}) are measured in the sample container 11 to which the reaction liquid is supplied through the liquid supply line 37, the reaction liquid is discharged through the liquid discharge line 35 to the outside of the sample container 11.

In the present description, the terms “including” and “containing” include the meaning of “consisting of” and “consisting essentially of”.

### EXAMPLES

Hereinafter, the present invention will be described using experimental examples in order to help understanding of a configuration and an effect of the present invention. However, the present invention is not limited by these experimental examples. The following experiments were performed at room temperature (25±5° C.) under an atmospheric pressure condition unless otherwise specified. Unless otherwise specified, the units “%” and “part” described below mean “mass %” and “part by mass”, respectively.

### Experimental Example 1 Selection of Internal Standard Substance (Dye) Used in Indicator Solution

As described in PTL 3, the percarboxylic acid concentration in an equilibrium mixture containing a percarboxylic acid and hydrogen peroxide can be selectively quantified by adding potassium iodide to the equilibrium mixture to generate iodine, and measuring the amount of light transmitted through the mixture (this method is referred to as “KI method” for convenience). In the KI method, the wavelength range of light used for measurement is 440 to 600 nm. This is because at a wavelength of shorter than 440 nm, the peak overlaps with the peak of a polyiodide ion having an absorption maximum around 350 nm, and at a wavelength of longer than 600 nm, absorption is so weak that an accurate percarboxylic acid concentration is difficult to obtain (see PTL3, paragraph [0013]).

For this reason, as the internal standard substance (dye) used in the indicator solution, a blue dye is desirable that has an absorption peak at a wavelength of 600 nm or longer and absorbs red light. Known blue dyes include Brilliant Blue, Crystal Violet, Phycocynin, copper phthalocyanine, Alcian Blue, Suminol Milling Brilliant Sky Blue SE (N), Suminol Fast Blue PR conc., and Astrazon Blue FGRL 200% micro.

In this experiment, among these blue dyes, Brilliant Blue (hereinafter, sometimes referred to as “BB”) and Crystal Violet (hereinafter, sometimes referred to as “CV”) were used to evaluate the suitability of the indicator solution as an internal standard substance for measurement of a percarboxylic acid concentration.

### 1. Preparation of Test Liquid

### (a) Dye Solution

About 0.2 g of BB or CV was weighed out, and purified water was added so that the resulting liquid had a volume of 200 mL. Dilutions of a 10 fold dilution series were prepared with a whole pipette and a volumetric flask (BB dye solution, CV dye solution).

### (b) Potassium Iodide Containing Solution (KI Solution)

Into purified water, 0.48 g of potassium iodide, 0.5 g of sodium benzoate, and 0.3 g of citric acid (anhydrous) were added and mixed, and the mixture was diluted with purified water to 1 L.

### (c) Indicator Solution

Each dye solution (BB dye solution, CV dye solution) and the KI solution prepared above were mixed to prepare an indicator solution (BB indicator solution, CV indicator solution).

### (d) Peracetic Acid Diluted Solution

A disinfectant solution containing peracetic acid at a concentration of 6% (Acecide reagent 1: manufactured by Saraya Co., Ltd.) was diluted with purified water so that the peracetic acid concentration was about 0.2% to prepare a peracetic acid diluted solution.

### 2. Test Method

### (a) Confirmation of Spectrum

An absorption spectrum at 800 nm to 250 nm was measured for each dye solution, the KI solution, each indicator solution, and a mixture of each indicator solution and the peracetic acid diluted solution, using an ultraviolet-visible spectrophotometer (with quartz cell having an optical path length of 10 mm: UV-2600, manufactured by SHIMADZU CORPORATION).

### (b) Measurement of Concentration

1) A certain amount of each indicator solution was put into a 20 mL volumetric flask, and then the peracetic acid diluted solution was mixed in an amount of 0, 0.1, 0.2, 0.3, 0.4, or 0.5 mL, and the indicator solution was added so that the resulting liquid had a volume of 20 mL.
2) One minute after stirring and mixing the liquid, an absorption spectrum was measured.

### 3. Test Results

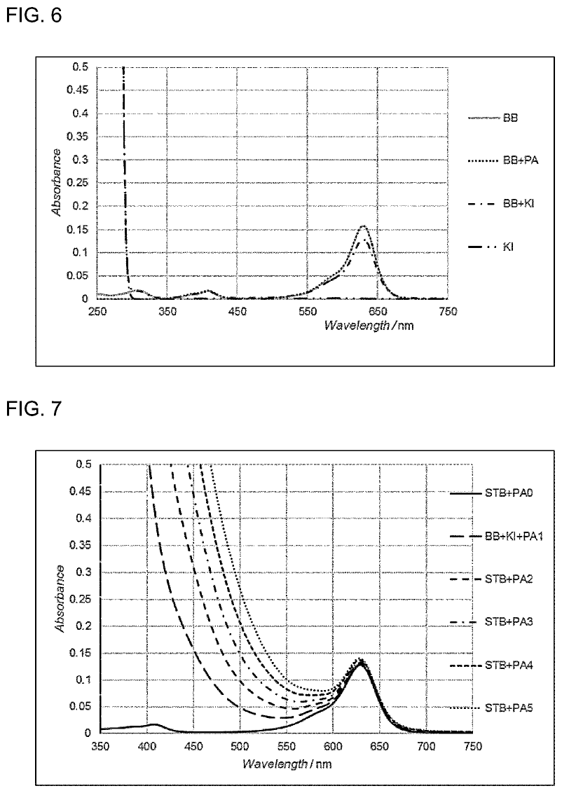

FIG. 6 shows absorption spectra of the BB dye solution (BB), the KI solution (KI), the BB indicator solution (BB+KI), and a mixture of the BB dye solution and the peracetic acid diluted solution (BB+PA). The BB dye solution (BB) showed a peak having an absorption maximum at 629.5 nm, and very small absorption was observed at 430 nm to 380 nm. The KI solution was colorless and transparent, no absorption peak was observed at a wavelength longer than 300 nm, and strong absorption was observed at a wavelength shorter than 300 nm. The shape of the peak from 670 nm to 540 nm of the BB dye solution (BB) was similar to the peak shape of the BB indicator solution (BB+KI) or the mixture of the BB dye solution and peracetic acid (BB+PA), and influence of KI or peracetic acid was not observed.

FIG. 7 shows absorption spectra of mixtures of the BB indicator solution (denoted as BB+KI: STB) and different amounts of the peracetic acid diluted solution. In FIG. 7, “STB+PA0” refers to the BB indicator solution only, and STB+PA1 to STB+PA5 refer to mixtures of the BB indicator solution with the peracetic acid diluted solution added in an amount increased from 0.1 mL to 0.5 mL, respectively. Immediately after the peracetic acid diluted solution was mixed with the BB indicator solution, the color of the resulting solution changed from blue to green. The BB indicator solution (STB+P0) to which the peracetic acid diluted solution was not added showed only absorption by BB (the solution color was blue), and the larger the amount of the peracetic acid diluted solution added was from STB+PA1 to STB+PA5, the higher the absorption intensity at less than 600 nm was, and accordingly, the higher the degree of greenness of the liquid became.

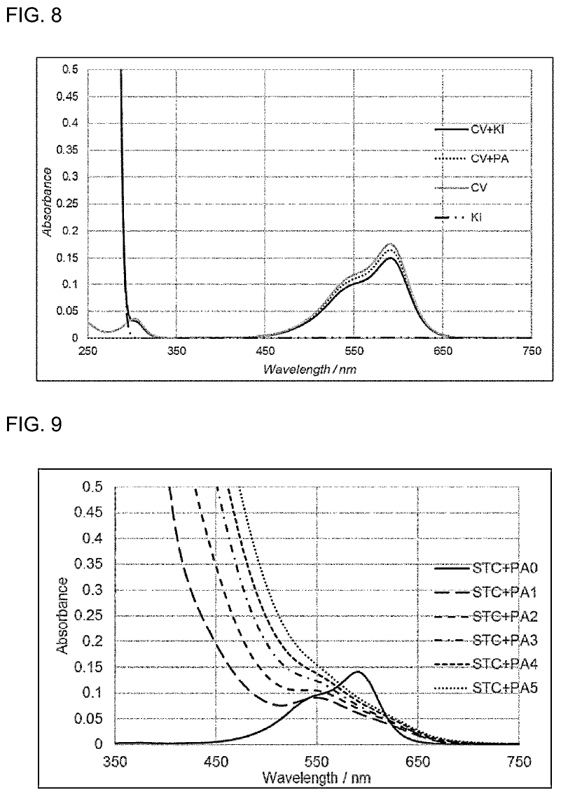

FIG. 8 shows absorption spectra of the CV dye solution (CV0, CV), the KI solution (KI), the CV indicator solution (CV+KI), and a mixture of the CV dye solution and the peracetic acid diluted solution (CV+PA). The CV dye solution (CV) showed two peaks with absorption maxima at 590 nm and 540 nm. In addition, a small absorption was observed near 310 nm, and as a result of confirmation with a CV dye solution (CV0) having 10 times concentration, specific absorption having a peak at 310 nm was observed. The shape of the peak from 650 nm to 450 nm of the CV dye solution (CV) was similar to the peak shape of the CV indicator solution (CV+KI) or the solution obtained by adding the peracetic acid diluted solution to the CV dye solution (CV+PA), and influence of KI or peracetic acid was not observed.

FIG. 9 shows absorption spectra obtained by adding different amounts of the peracetic acid diluted solution to the CV indicator solution (STC). “STC+PA0” refers to the CV indicator solution alone, and “STC+PA1” to “STC+PA5” refer to solutions obtained by adding the peracetic acid diluted solution in an amount of 0.1 to 0.5 mL to the CV indicator solution (STC), respectively. When the peracetic acid diluted solution was mixed with the CV indicator solution, the peak shape of the CV dye solution changed, and the absorption at 590 nm decreased. Furthermore, the absorption at 540 nm was present in and overlapped with the tail portion of the absorption peak of the polyiodide ion.

As shown in the above results, the shape of the reference peak of CV changed when KI and peracetic acid were mixed. Meanwhile, unlike CV, BB had no reactivity with KI, PA, and the reacted substance, and no change was observed in the shape of the absorption peak. From this, it has been confirmed that among blue dyes, BB can be used as an internal standard substance (dye) to be blended in an indicator solution in measurement of a concentration of a percarboxylic acid using the KI method. All of Phycocynin, copper phthalocyanine, Alcian Blue, Suminol Milling Brilliant Sky Blue SE (N), Suminol Fast Blue PR conc., and Astrazon Blue FGRL 200% micro lacked suitability as an internal standard substance.

### Experimental Example 2 Determination of Wavelength Range of BB Indicator Solution

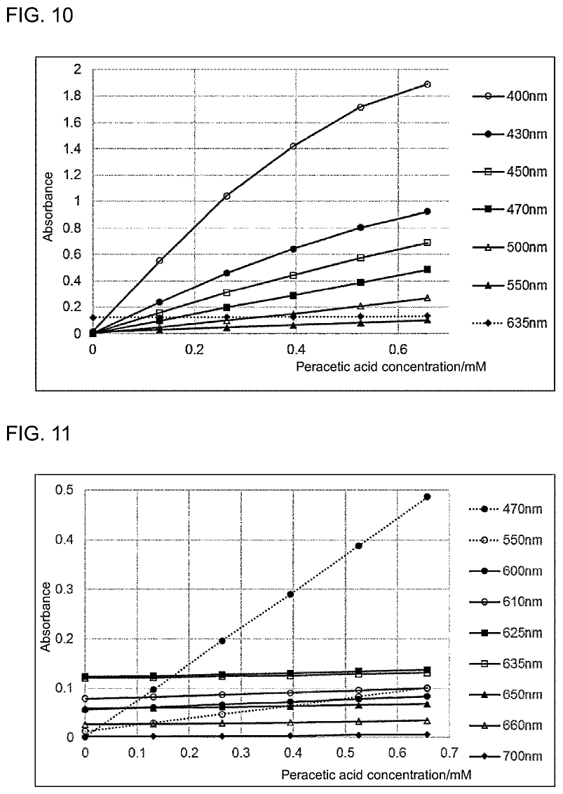

FIG. 10 shows a graph obtained by plotting the peracetic acid concentration in a measurement solution along the horizontal axis and the absorbance measured at a wavelength of 635 nm and a wavelength of 400 nm to 550 nm along the vertical axis on the basis of the spectra in FIG. 7 obtained in Experimental Example 1 (the absorption spectra obtained by adding different amounts of the peracetic acid diluted solution to the BB indicator solution). Furthermore, FIG. 11 shows a graph obtained by enlarging the scale of the absorbance along the vertical axis and plotting the peracetic acid concentration in a measurement solution along the horizontal axis and the absorbance measured at a wavelength of 470 nm to 700 nm along the vertical axis.

As can be seen from the graphs, a good linear relationship between the peracetic acid concentration and the absorption of polyiodide ions was observed in the wavelength range of 430 nm to 550 nm. A curve was obtained at 400 nm. The wavelength range providing a dye reference was 600 nm to 700 nm.

### Experimental Example 3 Evaluation of Quantification Accuracy

### 1. Preparation of Test Liquid

### (a) Indicator Solution

An indicator solution (pH 4) was prepared by dissolving components in purified water so as to have contents of BB of 16 mg/L, KI of 480 mg/L, citric acid of 300 mg/L, and sodium benzoate of 500 mg/L.

### (b) Peracetic Acid Diluted Solution

A disinfectant solution containing peracetic acid at a concentration of 6% (Acecide reagent 1: manufactured by Saraya Co., Ltd.) was diluted with purified water so that the peracetic acid concentration was 0.01%, 0.05%, 0.10%, 0.15%, 0.20%, 0.25%, and 0.30%, and thus peracetic acid diluted solutions were prepared.

2. Test method

### (a) Preparation of Calibration Curve

1) To the indicator solution, 0.1 mL of the peracetic acid diluted solution at each concentration was accurately added, and the indicator solution was added so that the resulting solution accurately had a volume of 20 mL to obtain a calibration curve measurement solution.
2) The absorbance (I₄₇₀) at 470 nm was measured with an ultraviolet-visible spectrophotometer (with quartz cell having an optical path length of 10 mm: UV-2600, manufactured by SHIMADZU CORPORATION).
3) The absorbance was plotted along the vertical axis, and the peracetic acid concentration in the calibration curve measurement solution was plotted along the horizontal axis to prepare a calibration curve.

### (b) Recovery Test Method

1) An arbitrary amount of the peracetic acid diluted solution having a peracetic acid concentration of 0.01% (100 ppm) was mixed with 20 mL of the indicator solution, and the absorbance (I₄₇₀, I₆₃₀) at 470 nm and 630 nm was measured.
2) From the absorbance I₁₄₇₀, the peracetic acid concentration in the measurement solution was determined using the calibration curve prepared above.
3) From the change in the absorbance I₆₃₀ at a wavelength of 630 nm, the volume (mL) of the peracetic acid diluted solution added was determined, and the peracetic acid concentration in the peracetic acid diluted solution was calculated.

### 3. Test Results

FIG. 12 shows the prepared calibration curve. Table 1 shows the results of the recovery test.

TABLE 1

| | | | | | | Amount of | | | |
|---|---|---|---|---|---|---|---|---|---|
| | | | | | | peracetic | | | Peracetic acid |
| Peracetic acid | | Amount of | | | | acid diluted | | | concentration |
| concentration | Amount of | peracetic | | | | solution added | Peracetic acid | Peracetic acid | in added |
| in peracetic | internal | acid diluted | | I₆₃₀ | I₄₇₀ | determined | concentration | concentration | peracetic |
| acid diluted | standard | solution | Initial | after | after | from change | determined | determined | acid diluted |
| solution ppm | indicator mL | added mL | I₆₃₀ | mixing | mixing | in I₆₃₀ ML | from I₄₇₀ mM | from I₄₇₀ ppm | solution ppm |
| 100 | 20 | 1 | 0.6249 | 0.5951 | 0.0213 | 1.0 | 0.016 | 1.185 | 99 |
| 100 | 20 | 5 | 0.6249 | 0.5023 | 0.0900 | 4.9 | 0.066 | 5.006 | 102 |
| 100 | 20 | 7 | 0.6249 | 0.4656 | 0.1157 | 6.8 | 0.085 | 6.436 | 101 |
| 100 | 20 | 10 | 0.6249 | 0.4210 | 0.1501 | 9.7 | 0.110 | 8.349 | 102 |
| 100 | 20 | 15 | 0.6249 | 0.3608 | 0.1930 | 14.6 | 0.141 | 10.736 | 102 |

From these results, the peracetic acid concentration of the peracetic acid diluted solution calculated in the recovery test was 99 ppm to 102 pm with respect to the peracetic acid concentration of 100 ppm of the peracetic acid diluted solution actually added, and the recovery rate was 99% to 102%. Thus, it has been confirmed that the concentration of peracetic acid in a peracetic acid-containing solution can be accurately measured with an error within +2% by using the BB internal standard indicator of the present invention.

### DESCRIPTION OF REFERENCE NUMERALS

1 Measurement unit
11 Measurement sample unit
121 Light emitting unit
12 Light source
12-1 First light source
12-2 Second light source
13 Light receiving unit
2 Measurement unit
21 Storage unit
22 Operation unit
3 Liquid dispensing system
31 First chamber
32 Indicator supply line
33 Second chamber
34 Test sample supply line
35 Liquid discharge line
36 Mixing chamber
37 Liquid supply line
4 Electrical signal processing unit
5 Output unit
51 Display unit
52 Communication unit

1. A method for measuring a percarboxylic acid concentration in a percarboxylic acid-containing aqueous solution (test sample), the method comprising the steps of:
(1) mixing an aqueous solution (indicator solution) containing an iodide salt and Brilliant Blue FCF with a test sample to cause a reaction between a percarboxylic acid and the iodide salt while the Brilliant Blue FCF is present;
(2) measuring an intensity (first light intensity) of transmitted light or reflected light at a wavelength (first wavelength) in a wavelength range of 600 to 700 nm and an intensity (second light intensity) of transmitted light or reflected light at a wavelength (second wavelength) in a wavelength range of 440 to 600 nm for a solution (reaction liquid) after the reaction;
(3) calculating and determining a percarboxylic acid concentration per total amount of the test sample and the indicator solution from the second light intensity obtained in the step (2) using a correlation of a second light intensity measured for a reaction liquid of a percarboxylic acid-containing aqueous solution (standard sample) having a known percarboxylic acid concentration and the indicator solution with a percarboxylic acid concentration obtained by converting the known percarboxylic acid concentration of the standard sample into a percarboxylic acid concentration per total amount of the standard sample and the indicator solution, the known percarboxylic acid concentration set to various known percarboxylic acid concentrations; and
(4) measuring a first light intensity of the indicator solution used in the step (1), and calculating and determining a percarboxylic acid concentration of the test sample from the percarboxylic acid concentration per total amount of the test sample and the indicator solution determined in the step (3) on the basis of a difference from the first light intensity of the reaction liquid obtained in the step (2).

2. The method according to claim 1, comprising, before the step (1), a step of measuring an intensity (first light intensity) of transmitted light or reflected light at the wavelength (first wavelength) in the wavelength range of 600 to 700 nm and/or an intensity (second light intensity) of transmitted light or reflected light at the wavelength (second wavelength) in the wavelength range of 440 to 600 nm for the aqueous solution (indicator solution) containing the iodide salt and the Brilliant Blue FCF.

3. The method according to claim 1, wherein the second wavelength is 470 nm, and/or the first wavelength is 630 nm.

4. The method according to claim 1, wherein the percarboxylic acid is peracetic acid, and/or the iodide salt is potassium iodide.

5. The method according to claim 1, wherein a mixed liquid, prepared in the step (1), of the indicator solution and the test sample has a pH of 1 to 6.

6. The method according to claim 1, wherein the mixed liquid, prepared in the step (1), of the indicator solution and the test sample has a concentration of the percarboxylic acid of 0.01 to 200 ppm.

7. An indicator solution to be used for measuring a percarboxylic acid concentration in a percarboxylic acid-containing aqueous solution (test sample), the indicator solution comprising:
Brilliant Blue FCF as an internal standard substance; and
an iodide salt as a coloring substance.

8. The indicator solution according to claim 7, wherein the percarboxylic acid is peracetic acid, and/or the iodide salt is potassium iodide.

9. The indicator solution according to claim 7, having a pH of 1 to 6.

10. The indicator solution according to claim 7, further comprising at least one selected from the group consisting of pH adjusting agents, preservatives, stabilizers, and sequestering agents.

11. A device capable of measuring a percarboxylic acid concentration in a percarboxylic acid-containing aqueous solution (test sample), the device comprising:
(A) a measurement unit 1; and
(B) a determination unit 2,
(A) the measurement unit 1 including:
(a1) a sample container 11 that contains a measurement test liquid;
(a2) a light emitting unit 121 including a light source 12 that emits light at two wavelengths of a wavelength (first wavelength) in a wavelength range of 600 to 700 nm and a wavelength (second wavelength) in a wavelength range of 440 to 600 nm to the sample container 11 containing a measurement test liquid; and
(a3) a light receiving unit 131 including a light receiving element 13 that detects an intensity (light intensity) of transmitted light or reflected light of the light emitted from the light emitting unit 121, the transmitted light or the reflected light from the sample container 11,
the measurement test liquid being the indicator solution according to claim 7 or a mixed liquid of the indicator solution and a test sample,
(B) the determination unit 2 including (b1) a storage unit 21 and (b2) an operation unit 22,
(b1) the storage unit 21 configured to store a correlation of a light intensity measured at the second wavelength for a reaction liquid of a percarboxylic acid-containing aqueous solution (standard sample) having a known concentration and the indicator solution with a percarboxylic acid concentration obtained by converting the known concentration of a percarboxylic acid in the standard sample into a percarboxylic acid concentration per total amount of the standard sample and the indicator solution,
(b2) the operation unit 22 configured to
(i) calculate a percarboxylic acid concentration, for a reaction liquid of the test sample and the indicator solution contained in the sample container 11, converted per total amount of the test sample and the indicator solution in the measurement unit 1 on the basis of the correlation from the light intensity (I²_{fin}) measured at the second wavelength, and
(ii) determine a percarboxylic acid concentration in the test sample on the basis of a difference between a light intensity (I¹ᵢₙᵢ) measured at the first wavelength for the indicator solution and a light intensity (I¹_{fin}) measured at the first wavelength for the reaction liquid of the indicator solution and the test sample, from the percarboxylic acid concentration calculated in (i).

12. The device capable of measuring a percarboxylic acid concentration according to claim 11, further comprising (C) a liquid dispensing system 3 including:
a first chamber 31 that contains the indicator solution, and/or a second chamber 32 that contains the test sample; and
an indicator supply line 33 that delivers the indicator solution contained in the first chamber 31 to the sample container 11, and/or a test sample supply line 34 that delivers the test sample contained in the second chamber to the sample container 11.

13. The device capable of measuring a percarboxylic acid concentration according to claim 12, wherein the liquid dispensing system 3 further includes a liquid discharge line 35 that discharges the reaction liquid delivered to the sample container 11 outside the sample container 11.

14. The device capable of measuring a percarboxylic acid concentration according to claim 12, comprising a mixing chamber 36 that mixes the indicator solution and the test sample among the first chamber 31, the second chamber 32, and the sample container 11,
the mixing chamber configured so that to the mixing chamber 36, the indicator solution is delivered from the first chamber 31 through the indicator supply line 33 and the test sample is delivered from the second chamber 32 through the test sample supply line 34, separately, and a liquid mixed in the mixing chamber 36 is delivered to the sample container 11 through a liquid supply line 37.

15. The device capable of measuring a percarboxylic acid concentration according to claim 11, wherein
the light source 12 includes a first light source 12-1 that emits light having a wavelength (first wavelength) in a wavelength range of 600 to 700 nm to the sample container 11 and a second light source 12-2 that emits light having a wavelength (second wavelength) in a wavelength range of 440 to 600 nm to the sample container 11, the first light source is a red light emitting diode (red LED) or a light emitting diode having a wavelength range including a wavelength range of 600 to 700 nm, and the second light source is a blue light emitting diode (blue LED) or a light emitting diode having a wavelength range including a wavelength range of 440 to 600 nm, and
the light receiving element is a photodiode.

16. The device capable of measuring a percarboxylic acid concentration according to claim 11, wherein the percarboxylic acid is peracetic acid, and/or the iodide salt is potassium iodide.
